(19) United States
(12) Patent Application Publication
(10) Pub. No.: US 2007/0176377 A1
(43) Pub. Date: Aug. 2, 2007

(54) Land based towing apparatus

(76) Inventor: Allen S. Peek, Lake Oswego, OR (US)

Correspondence Address: MARGER JOHNSON & MCCOLLOM, P.C., 210 SW MORRISON STREET, SUITE 400, PORTLAND, OR, 97204, US

(21) Appl. No.: 11/346,692

(22) Filed: Feb. 2, 2006

(51) Int. Cl. B62B 15/00

(52) U.S. Cl. 280/24

(57) ABSTRACT

A method, including a system and apparatus for achieving said method, for towing a user on land including providing a motorized vehicle, mounting a tower device to the motorized vehicle, and attaching one end of a tow rope to the tower, wherein the opposite end of the tow rope includes a handle for towing the user.

### BACKGROUND

The invention relates to a land based towing apparatus used for towing a person or object attached thereto.

Snowboarding, skiing and other sports relying on accelerating a person down a hill have been popular activities in nearly every region of the world. Gravity and the slope of the mountain typically provide the person with a means of acceleration. In parts of the world which are relatively flat and without mountains, these sports have understandably not gained as much popularity. Similarly, mountainous locations that have not been developed to include ski resorts or more specifically ski lifts, also pose problems for transporting people to the top of the mountain.

Other sports which do not necessarily rely on gravity to accelerate a person, for example skateboarding or rollerblading, may nevertheless benefit from acceleration due to an incline to perform various maneuvers which would be difficult on a flat surface. As less conventional sports such as grass-skiing and sand-boarding become more popular, there is similarly a need to provide a means of acceleration on different terrains that are relatively flat.

One answer to the above problems has been to build artificial snow ramps and skate parks in these regions of the world. However these solutions are expensive and physically confined to the geographic location where they are set up.

Tow devices which have been attached to self-propelled vehicles such as all-terrain vehicles (ATV), four wheel drive (4WD) vehicles, or snowmobiles have typically been fitted to a tow ball or tow bar located approximately at the vehicle frame height. This position of the tow device is not optimally positioned for towing some objects, for example, due to the limited ground clearance of a tow rope or tether. Similarly, the angle of the tow rope with respect to the object being towed may result in less stable towing dynamics and inferior performance.

The present invention addresses these and other problems associated with the prior art.

### SUMMARY OF THE INVENTION

In one embodiment, a towing system is disclosed for towing a user on land comprising a motorized vehicle and a tower apparatus attached to the motorized vehicle. The tower apparatus may include an attachment member for receiving a tow rope, wherein one end of the tow rope includes a handle. In one embodiment, the attachment member is located above a rear portion of the motor vehicle.

In yet another embodiment, the towing system includes a vehicle operator compartment and support members, wherein the support members are located substantially behind the vehicle operator compartment. A towing system is further disclosed wherein the tower apparatus has an adjustable height, or wherein the tow rope is attachable to the tower apparatus at a plurality of heights. A method is also disclosed to include adjusting the height of the tower device by extending or collapsing mounting legs of the tower device, for example.

In one embodiment, the towing system may be employed for grass-skiing, sand-skiing, sand-boarding, skateboarding, roller-blading, slalom boarding, trick/freestyle boarding, ice skating, snow skating, longboarding, land kite boarding, carve boarding, inner tubing, sledding, or street luging. Similarly, the motorized vehicle in the towing system may comprise an all-terrain vehicle (ATV), snowmobile, snowcat, dune-buggy, four-wheel drive (4WD) vehicle, dirt bike or motorcycle.

In another embodiment, a towing apparatus for towing a user on land is disclosed, comprising a motorized recreational vehicle, a tower device extending above and connected to a first side and a second side of the motorized vehicle and an attachment member for receiving a tow rope.

In yet another embodiment, a method is disclosed for towing a user on land comprising providing a motorized vehicle, mounting a tower device to the motorized vehicle, and attaching one end of a tow rope to the tower. The opposite end of the tow rope may include a handle for towing the user. The method is further disclosed wherein the tower device may have attachment ends. The method may include connecting a first attachment end and a second attachment end to a first side of the motorized vehicle, and attaching a third attachment end and a fourth attachment end to a second side of the motorized vehicle.

In one embodiment, first and third attachments ends are connected at an approximate midpoint of the first and second sides, and second and fourth attachment ends are connected at an approximate rear portion of the first and the second sides.

In another embodiment, first and third attachments ends are located at either end of a first support structure, and second and fourth attachment ends are located at either end of a second support structure. The first and second support structures may be connected together with a lateral support.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 is a right side view of a motorized land-based vehicle with towing apparatus and a person being towed behind.

FIG. 2 is an enlarged perspective view of a preferred embodiment of the towing apparatus.

FIG. 3 is an exploded perspective view of an attaching end of the towing apparatus.

FIG. 4 is right side view of the towing apparatus as mounted to a partial view of a motorized vehicle.

FIG. 5 is a perspective view of an alternate embodiment of the towing apparatus.

FIG. 6 is a perspective view of another alternate embodiment of the towing apparatus.

FIG. 7 is a right side view of yet another alternate embodiment of the towing apparatus when attached to a motorized vehicle.

FIG. 8 is a perspective view of an alternate embodiment of an adjustable height tower support and an attaching end.

### DETAILED DESCRIPTION

Disclosed herein is an apparatus and method for towing a person or object behind a land based towing apparatus such as an all-terrain vehicle (ATV) or snowmobile. In one embodiment of the invention, a tower is mounted on a motorized vehicle such that a tow rope may be attached to the tower, with an opposite end connected to the person or object being towed.

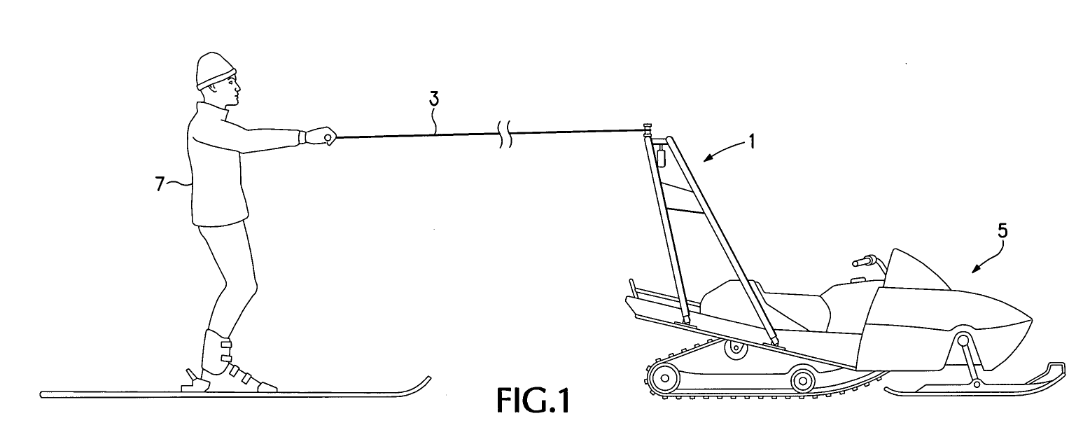

FIG. 1 shows one embodiment in which a tower 1 is mounted to a motorized vehicle 5 such as a snowmobile. In this example, a tow rope 3 is connected to the tower 1 with an opposite end of the tow rope 3 being held by a user 7 who may be skiing or boarding, for example. The length of the tow rope 3 may vary depending on the nature of the activity being performed by the user 7, for example arial tricks may require a different amount of tow rope 3 than slalom skiing. Similarly, the length of the tow rope 3 may vary depending on the height of the user 7, or if the tow rope 3 is instead attached to a sled, for example. When the user 7 is being towed in open terrain, such as on a beach, the length of the tow rope 3 in one embodiment may be relatively long as compared to when the user 7 is being towed in more confined areas, such as on a trail where other vehicles may be present. A shorter length tow rope 3 may be advisable for safety reasons when used in confined areas. In certain instances, such as when towing a parasail, kite board or hand glider, the length of the tow rope 3 may extend several hundred feet or more. Average speeds of the flight may vary depending on the wind speed and speed of the motorized vehicle 5.

As the motorized vehicle 5 accelerates and maneuvers across the terrain, the user 7 will tend to follow the general direction of the motorized vehicle 5 other than intermediate changes of direction that are controlled by the user 7. For example, the user 7 is able to move back and forth laterally, or even up and down, according to the limitations of the length of the tow rope 3 and speed of the motorized vehicle 5.

This acceleration of the motorized vehicle 5, therefore, simulates the acceleration that a user 7 would experience when skiing down an incline of a mountain. Rather than the speed of the user 7 being constrained by the slope of the hill and the skiing equipment, the user's speed is primarily determined according to the speed of the motorized vehicle 5. The speed of the motorized vehicle 5 may be adjusted to fit any skill level of the user 7, including a novice who would prefer slower speeds associated with a minimally sloped hill.

Similarly, the user 7 is able to perform tricks typically associated with relatively steep inclines, such as arial tricks if the snowmobile 5 is moving at a rapid pace. The user 7 may take jumps located in a wide path associated with the general direction of the snowmobile 5 due to the user's ability to independently move left and right in a lateral direction. In this way, the motorized vehicle 5 does not need to take the same jumps as the user 7.

The applications discussed herein are frequently performed at speeds ranging between fifteen and twenty miles per hour, for example, but may be performed at different speeds according to the application, preference of the user 7, and an available power of the motorized vehicle 5. Slower speeds may be advisable for a user 7 who is a novice or who wishes to exercise caution, as slower speeds may be less dangerous in certain applications.

It should be obvious to one skilled in the art that the motorized vehicle 5 discussed above may include other types of motorized vehicles other than snowmobiles such as those typically used for recreational use including ATVs, sand-buggies, 4WD vehicles, snowcats, motorcycles and dirt bikes, for example. Similarly, the user 7 does not need to be a snow skier or snowboarder, but it should be understood that the user 7 disclosed herein indicates any person who enjoys grass-skiing, sand-skiing, sand-boarding, skateboarding, roller-blading, slalom boarding, trick/freestyle boarding, ice skating, snow skating, longboarding, land kite boarding, carve boarding, inner tubing, sledding, street luging, or other related activities. Furthermore, the scope of this invention anticipates and claims applications involving towing hyper-light air vehicles including windsurfers, kite gliders, parasails, and hang gliders that may be towed by a land-based motorized vehicle, for example. In some of these activities, the tow rope 3 may be held by the user 7 being towed, whereas for other activities, the tow rope 3 may be connected to an apparatus that a person is riding on or otherwise connected to.

Tower Construction

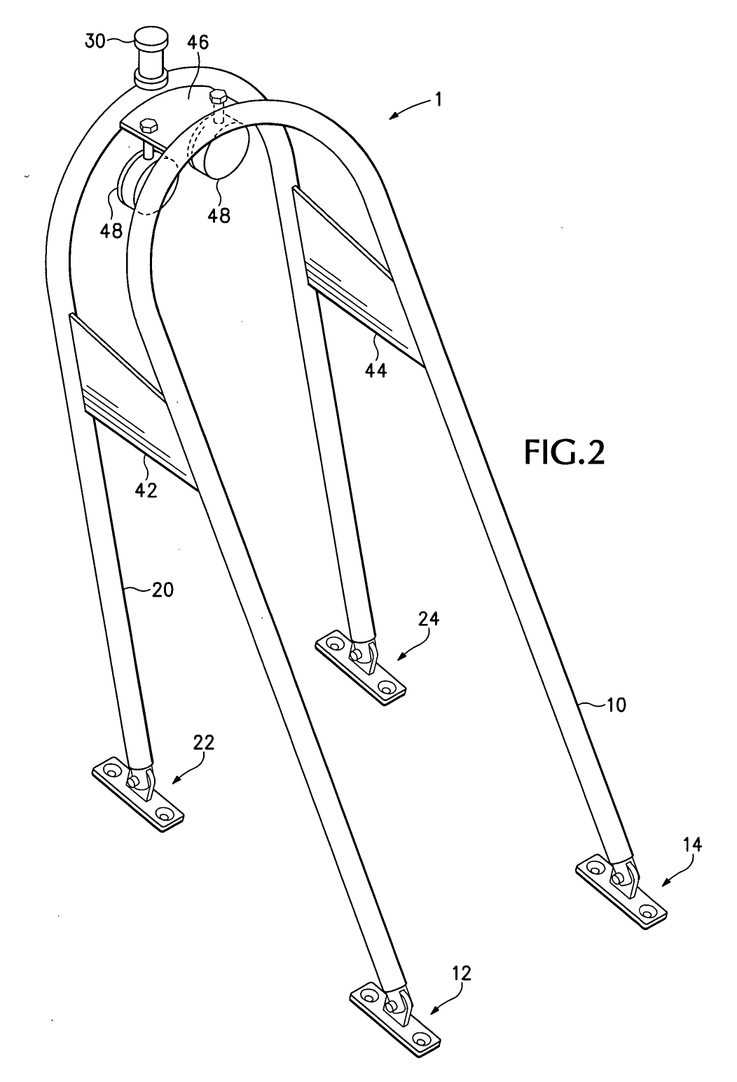

Turning now to FIG. 2, an enlarged perspective view of one embodiment of the tower 1 is shown for clarity. It can be seen that the tower 1 may include two or more supports such as forward support 10 and rear support 20. In a preferred embodiment shown here, the supports 10 and 20 are hollow metallic structures that are curved to form attaching ends 12, 14, 22 and 24. For example, forward support 10 includes a right forward attaching end 12 and left forward attaching end 14, whereas rear support 20 includes a right rear attaching end 22 and a left rear attaching end 24. The attaching ends 12, 14, 22 and 24 are configured to attach to a frame of the motorized vehicle 5, which will be described in more detail later. In one embodiment, the supports 10 and 20 are round aluminum or steel tubing.

A pylon 30 is rigidly mounted to one or both of the supports 10 and 20 in order to serve as a point of attachment for the tow rope 3 shown in FIG. 1. The pylon 30 is preferably mounted at approximately shoulder height for applications involving a user 7 who is holding the opposite end of the tow rope 3. An elevated height, with relation to the rest of the motorized vehicle 5, allows the user 7 to obtain more elevation during arial tricks. A relatively parallel tow rope also provides for a more stable towing system. It is advantageous that the user 7 does not experience a downward force that would be exerted if the tow rope 3 was attached to the tower 1 at a lower position. A height in this range may provide for better distribution of forces applied to the tower 1 and motorized vehicle 5. It may be preferable to locate the pylon 30 such that the force exerted by the tow rope 3 is approximately parallel with respect to the ground and exerted at the approximate center of gravity of the user 7.

The height of the pylon 30 may be varied according to the height of the user 7, or the particular application. For example, the tow rope 3 may be attached to a sled (not shown) rather than a user 7. A sled would have a lower center of gravity than a user 7, for example, and therefore it may be advantageous to lower the pylon 30 to approximately the same height as the center of gravity of the sled. Where the motorized vehicle 5 is operating on rough terrain, it may be advantageous to increase the height of the pylon 30 to provide additional ground clearance of the tow rope 3 to avoid snagging or catching the tow rope 3 on a branch or rock, for example. Similarly, if the user 7 is performing arial tricks, it may be advantageous to raise the pylon 30 to allow for higher jumping capability.

A further review of FIG. 2 shows that the supports 10 and 20 may be connected together by right and left connectors 42 and 44. Right and left connectors 42 and 44 are shown as a webbed design, being a formed sheet of metal or other rigid material that rigidly holds the supports 10 and 20 at a fixed distance from each other and also prevents independent movement of one support relative to the other. A further connector, such as top connector 46 may be included to provide additional strength of the tower 1 and impede twisting between the supports 10 and 20. Top connector 46 may include a rod, webbing or other connection, for example, or may alternatively be a welded connection between supports 10 and 20. In one embodiment, the connectors 42, 44 and 46 may be laser cut.

Optionally, lights or reflectors 48 may be mounted to the tower 1 when the motorized vehicle 5 is being operated in low visibility, for example at night, in areas of fog, or during a snowfall. The lights 48 may be battery powered or connected to the electrical system of the motorized vehicle 5. Electrical wiring may therefore be provided to accomplish this.

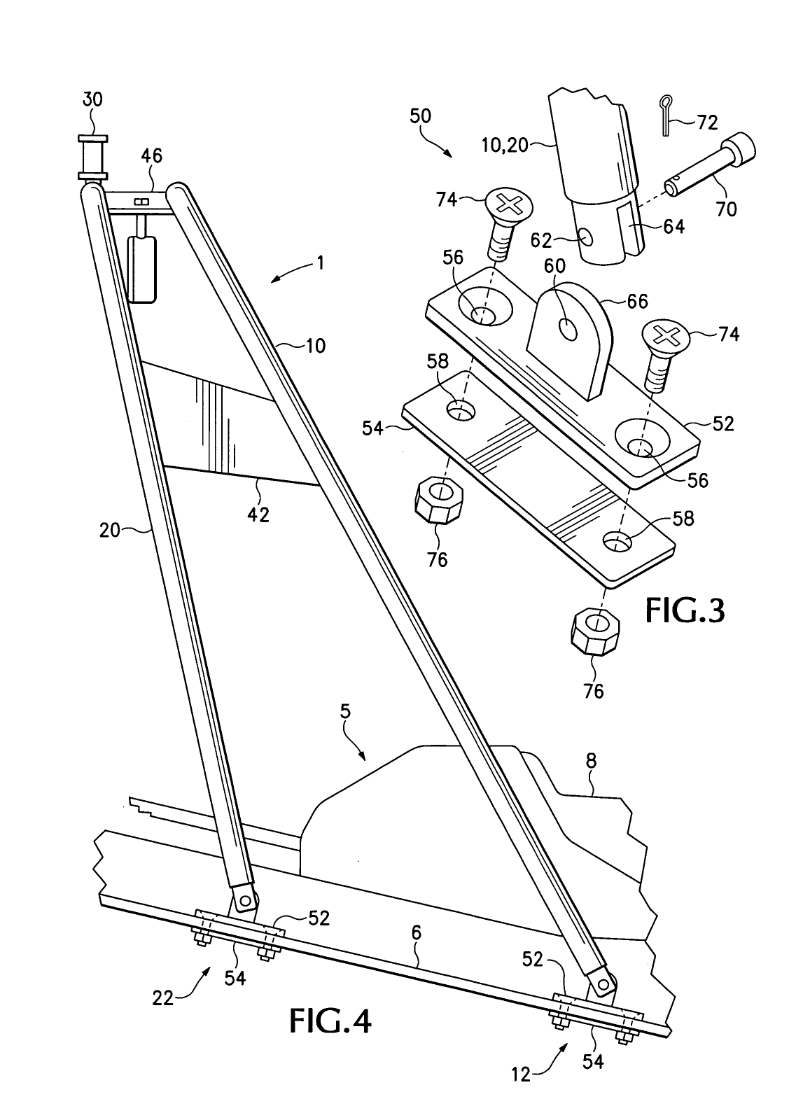

Turning now to FIG. 3, an exploded view of an attaching end 50 is shown. Attaching end 50 may be identical in design for each of the forward and rear attaching ends 12, 14, 22, and 24 previously discussed. The attaching end 50 is used to mount the forward and rear supports 10 and 20 to a frame of the motorized vehicle 5. An end of the forward or rear support 10 or 20 is attached to a mounting bracket 52 which may be secured to a frame of the motorized vehicle 5.

The mounting bracket 52 may include a vertical plate 66 having an inner hole 60. The mounting bracket 52 may farther include one or more upper mountings holes 56 for receiving a bolt 74, which may be situated one on either side of the vertical plate 66, for example. The attaching end 50 may further include a backing plate 54. The mounting bracket 52 and backing plate 54 may be so designed such that the bolt 74 passes through the upper mounting hole 56 through the frame of the motorized vehicle 5, through a lower mounting hole 58 of the backing plate 54, and then secured by a lock nut 76. The method of mounting the attachment end 50 to the motorized vehicle 5 will be explained in more detail later.

The support 10 or 20 may include a slot 64. The vertical plate 66 may be inserted into the slot 64 such that the inner hole 60 aligns with an outer hole 62 of the support 10 or 20. When the inner and outer holes 60 and 62 are thus aligned, a securing device such as a clevis pin 70 may be inserted into the holes 60 and 62 to secure the support 10 or 20 to the attaching end 50. A cotter pin 72 or other similar device may similarly be used to ensure that the clevis pin 70 is not inadvertently dislodged.

Tower Assembly

Turning now to FIG. 4, the tower 1 is shown attached to the frame 6 of the motorized vehicle 5. The frame 6 may include a flat metal plate or other type of runner that extends along the side of the vehicle frame, including foot gunnels for example. In a preferred embodiment, the tower 1 is mounted towards the rear of the motorized vehicle 5 such that the tower 1 does not obstruct a vehicle operator located on a vehicle seat 8. An exemplary description of how to mount the tower 1 to the motorized vehicle 5 is now provided, however those skilled in the art will recognize that there are many alternative methods of attachment that would function similarly.

First, evaluate the best position of the tower 1 relative to the frame 6 and vehicle seat 8. This may be accomplished by loosely placing the tower 1 on the frame 6 and then adjusting the position according to operator preference. Next, locate the position on either side of the motorized vehicle 5 where the supports 10 and 20 should be mounted to the vehicle frame 6. The mounting bracket 52 may be used as a template to mark the location of the mounting holes 56 and 58. Working first with the rear support 20, drill holes in the frame 6 according to the mounting hole locations identified above for the left and right rear attachment ends 22 and 24. The holes should be located the same distance from the rear of the motorized vehicle 5 on either side of the tower 1. While only the right side of the tower 1 is shown in FIG. 1, it should be understood that those elements on the left side are the mirror image of those on the right.

Next, insert the bolts 74 into each of the mounting holes, for example the upper mounting holes 56 located on either side of the vertical plate 66, such that the bolts 74 may also be dropped through the drilled holes in the frame 6. In this manner, the mounting bracket 52 is located on the top surface of the frame 6. Position the backing plate 54 on the underside of the frame 6 such that the bolts 74 may also pass through the lower mounting holes 58, and then secure the attachment end 50 to the frame 6 by spinning the lock nuts 76 tight on the bolts 74 until they contact the backing plate 54.

Pin the tower 1 to the rear attachment ends 22 and 24 with the clevis pin 70 and cotter pin 72. With the tower 1 thus secured to the frame 6 by attaching the rear support 20, the front attachment ends 12 and 14 may be located. For example, the front support 10 may be pinned to the front attachment ends 12 and 14. The bracket plate 52 associated with each of the front attachment ends 12 and 14 may then be used as a template to locate and drill holes in the frame 6. Then, bolts 74 may be used to secure the front support 10 to the frame 6, much the same as was discussed for the rear support 20.

With the tower 1 thus secured to the motorized vehicle 5, you are now ready to go out and ride.

### Alternate Embodiments

The tower 1 may be of varying size, shape and style. For example, the embodiments shown in FIGS. 1 and 3 may include supports 10 and 20 that are made of hollow aluminum tubing assembled in a swept-back style for added stability. The tower 1 may be located at different positions relative to the motorized vehicle 5, including fore, aft or alongside of the vehicle seat 8. The tower 1 may be constructed as variable height. The pylon 30 may be alternatively attached at different positions of the tower 1. A different means of attaching the tow rope 3 may be used, other than the pylon 30, to include an attachment ring or hook for example. A reel could be used to attach the tow rope 3 and thereby be used to adjust the length of the tow rope 3.

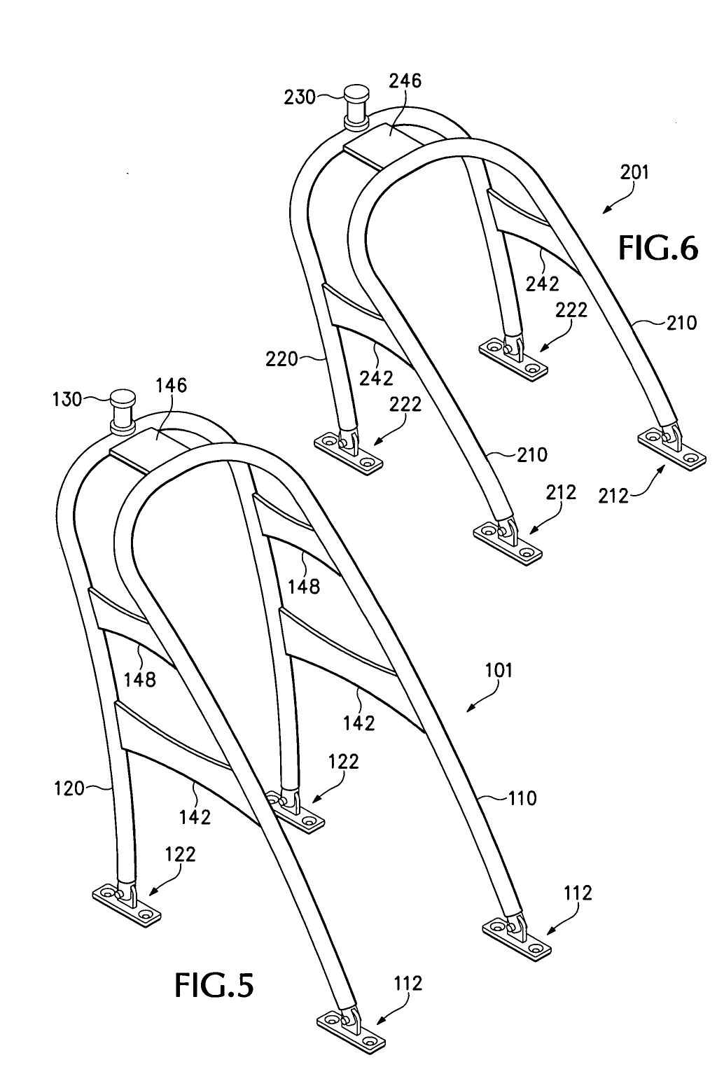

Alternate embodiments of the invention are now described, and are depicted by FIGS. 5-7, however these figures are not meant to provide an exhaustive description of those embodiments that are obvious variations of the disclosed embodiments or that are otherwise described and claimed herein.

FIG. 5 depicts an embodiment of a tower 101 including two sets of side connectors 142 and 148 connecting the front and rear supports 110 and 120 on the right and left sides of the tower. Top connector 146 is shown as connecting the top portions of supports 110 and 120 to provide additional stability to the tower 101 construction. The supports 110 and 120 are shown as being angled or having a swept back appearance, which may advantageously position the pylon 130 further rearward of support ends 112 and 122. The embodiment depicted in FIG. 5 may be used with any of the motorized vehicles previously discussed.

FIG. 6 depicts yet another embodiment of a tower 201 which includes a side connector 242 shown as connecting front and rear supports 210 and 220 on the right and left sides of the tower. Top connector 246 is shown as connecting the top portions of supports 210 and 220 to provide additional stability to the tower 201 construction. The supports 210 and 220 are shown as being angled or having a swept back appearance, which may advantageously position the pylon 230 further rearward of support ends 212 and 222.

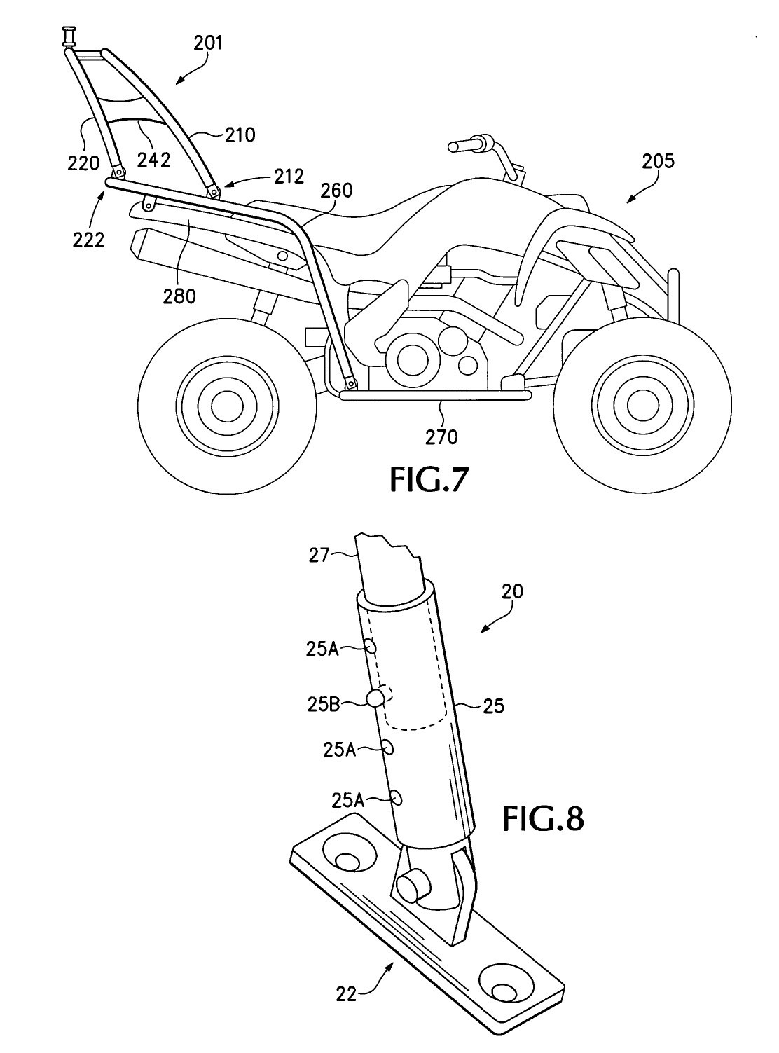

FIG. 7 illustrates the tower 201 of FIG. 6 as mounted to a motorized vehicle 205, which may be an ATV, for example. The tower 201 includes front and rear supports 110 and 120 and the side connector 242, as previously described. In some cases, the motorized vehicle 205 may not include a flat runner or foot gunnels, and so alternate means of mounting a tower 201 may be employed. One solution is to include a mounting bar 260 that may be connected to a footrest 270 or some other rigid surface on the side of the motorized vehicle 205. The mounting bar 260 may be formed so that it is further connected to a rear portion 280 of the vehicle frame. In this way, the mounting bar 260 forms a rigid connecting surface for further attaching to the mounting ends 212 and 222 located on the side of the tower 1. FIG. 7 illustrates the right side view of the tower 201 and motorized vehicle 205, and it should be recognized that an identical mounting system may be employed on the left vehicle side to further secure the tower 201 to the motorized vehicle 205. Similarly, the mounting bar 260 may be formed so that it wraps around the left and right side of the rear portion 280 of the vehicle frame. The mounting bar 260 may attach at a first end to the right footrest 270, attach at a second end to a left footrest identical to the right footrest 270 but hidden behind the motorized vehicle 205 in this view, and attach at its midpoint to the rear portion 280 of the vehicle frame.

The height of the pylon 30 may be varied according to different mounting locations on the tower 1, for example, or by adjusting the height of the tower 1. The supports shown in FIG. 2 may be designed, for example, to telescope and provide for varying overall heights. According to FIG. 8, a further embodiment is illustrated wherein one of the supports, for example support 20 may be further divided into an upper portion 27 and a lower portion 25 that is connected to the attaching end 22 as describe previously. The upper portion 27 may slide within the lower portion 25, or vice versa, and lock into place. For example, the lower portion 25 may include multiple holes 25A located at different heights. Furthermore, the upper portion 27 may include a retractable mechanism shown at 25B for engaging one of the multiple holes 25A. In this manner, support 20 may be locked together at a variable, or adjustable height. A means for providing variable length tubular extensions is well known to those skilled in the art and is not described further. A variable height tower may be further advantageous for transport of the tower 1, or where the motorized vehicle 5 having the tower 1 attached is operating in conditions having low overheard clearance.

Having described and illustrated the principles of the invention in a preferred embodiment thereof, it should be apparent that the invention may be modified in arrangement and detail without departing from such principles. I claim all modifications and variation coming within the spirit and scope of the following claims.

1. A towing system for towing a user on land comprising:
a motorized vehicle; and
a tower apparatus attached to the motorized vehicle including an attachment member for receiving a tow rope, wherein one end of the tow rope includes a handle.

2. The towing system according to claim 1 wherein the attachment member is located above a rear portion of the motor vehicle.

3. The towing system according to claim 2 including a vehicle operator compartment and support members, wherein the support members are located substantially behind the vehicle operator compartment.

4. The towing system according to claim 1 wherein the tower apparatus has an adjustable height.

5. The towing system according to claim 1 wherein the tow rope is attachable to the tower apparatus at a plurality of heights.

6. The towing system according to the claim 1 which is employed for grass-skiing, sand-skiing, sand-boarding, skateboarding, roller-blading, slalom boarding, trick/freestyle boarding, ice skating, snow skating, longboarding, land kite boarding, carve boarding, inner tubing, sledding, or street luging.

7. The towing system according to the claim 1 wherein the motorized vehicle comprises an all-terrain vehicle (ATV), snowmobile, snowcat, dune-buggy, four-wheel drive (4WD) vehicle, dirt bike or motorcycle.

8. A method for towing a user on land comprising:
providing a motorized vehicle;
mounting a tower device to the motorized vehicle; and
attaching one end of a tow rope to the tower, wherein the opposite end of the tow rope includes a handle for towing the user.

9. The method according to claim 8 wherein the tower device has attachment ends, and the method further includes connecting a first attachment end and a second attachment end to a first side of the motorized vehicle, and attaching a third attachment end and a fourth attachment end to a second side of the motorized vehicle.

10. The method according to claim 9 wherein the first and third attachments ends are connected at an approximate midpoint of the first and second sides, and wherein the second and fourth attachment ends are connected at an approximate rear portion of the first and the second sides.

11. The method according to claim 9 wherein the first and third attachments ends are located at either end of a first support structure, and the second and fourth attachment ends are located at either end of a second support structure.

12. The method according to claim 11 including forming the tower by connecting the first and second support structures together with a lateral support.

13. The method according to claim 8 wherein the tow rope is attached to the top of the tower device.

14. The method according to claim 8 which further includes adjusting the height of the tower device by extending or collapsing mounting legs of the tower device.

15. The method according to claim 8 which further includes attaching the tow rope to the tower device at a plurality of heights.

16. The method according to claim 8 wherein the motorized vehicle comprises an all-terrain vehicle (ATV), snowmobile, snowcat, dune-buggy, four-wheel drive (4WD) vehicle, dirt bike or motorcycle.

17. The method according to claim 8 wherein the user being towed is grass-skiing, sand-skiing, sand-boarding, skateboarding, roller-blading, slalom boarding, trick/freestyle boarding, ice skating, snow skating, longboarding, land kite boarding, carve boarding, inner tubing, sledding, or street luging.

18. A towing apparatus for towing a user on land comprising:
a motorized recreational vehicle;
a tower device extending above and connected to a first side and a second side of the motorized vehicle; and
an attachment member for receiving a tow rope, wherein the attachment member is located on top of the tower device.

19. The towing apparatus according to claim 18 wherein the attachment member has an adjustable height.

20. The towing apparatus according to claim 19 wherein one end of the tow rope includes a handle for towing the user.
